(19) United States
(12) Patent Application Publication
(10) Pub. No.: US 2005/0086790 A1
(43) Pub. Date: Apr. 28, 2005

(54) Press-in apparatus for Z profile sheet pile and press-in method of Z profile sheet pile

(75) Inventors: Akio Kitamura, Kami-gun (JP); Toshihiko Murata, Kochi-shi (JP); Yasuhiro Tanaka, Kochi-shi (JP)

Correspondence Address: OLIFF & BERRIDGE, PLC, P.O. BOX 19928, ALEXANDRIA, VA, 22320, US

(73) Assignee: GIKEN SEISAKUSHO CO., LTD., Kochi-shi (JP)

(21) Appl. No.: 10/750,871

(22) Filed: Jan. 5, 2004

(30) Foreign Application Priority Data
Oct. 24, 2003 (JP) 2003-364857

(51) Int. Cl. B23P 11/00; B21D 39/00

(52) U.S. Cl. 29/509; 29/715

(57) ABSTRACT

A press-in apparatus for a Z profile sheet pile, having a press-in section for grasping a Z profile sheet pile having clutches at both ends to press in, wherein the press-in section presses two Z profile sheet piles in at a time in a state where the two Z profile sheet piles are joined each other at clutches thereof.

### BACKGROUND OF THE INVENTION

1. Field of the Invention

The present invention relates to a press-in apparatus for a Z profile sheet pile comprising a press-in section for grasping a Z profile sheet pile having clutches at both end portions to press in, and a press-in method of a Z profile sheet pile.

2. Description of the Related Art

Generally, a pile press-in apparatus which can press a pile in or extract a pile by utilizing reaction force from a pile which has already been pressed in has been known. Earlier, a pile press-in apparatus comprises a saddle having a plurality of clamp parts for clamping top portions of piles which are pressed in the ground in line, a slide frame provided to be slidable back and forth to the saddle, a mast which is rotatably provided on the slide frame, and a chuck section which is provided on a front surface of the mast to be slidable up and down and comprises a chuck for grasping and holding a pile which is to be pressed in or to be extracted.

The slide frame is extended forward in a state of clamping piles which were pressed in the ground in a line by the clamp parts to support the saddle on the piles. A pile forward of the piles pressed in the ground is grasped and held by the chuck of the chuck section. The pile press-in apparatus presses the pile grasped and held by the chuck section in, in a state of receiving reaction force from the pressed-in piles which are clamped by the clamp parts. After releasing the piles clamped by the clamp parts, the clamp parts and the saddle are raised. The slide frame is shortened to pull the saddle to the chuck section side. The above operations are repeated, so that the pile press-in apparatus is capable of self-walking on the piles which are pressed in the ground in a line.

A pile is pressed in the ground while the pile press-in apparatus performing self-walking, and the slide frame is slid back and forth to the saddle. Thus, the chuck section presses two piles in back-and-forth directions.

The pile press-in apparatus can be applied to a steel pipe sheet pile, an H profile sheet pile, a Z profile sheet pile, a straight steel sheet pile, a concrete sheet pile or the like other than the above pile.

The Z profile sheet pile denotes, for example, a sheet pile 7 as shown in FIG. 5, which is not symmetric. The sheet pile comprises clutches 73 at both ends. In a chuck 101 of the chuck section for grasping the Z profile sheet pile 7 to press in, an approximately H-shaped through hole 102 through which the Z profile sheet pile 7 is inserted is formed. The chuck 101 comprises a fixed jaw 103 and a movable jaw 104 for attachably/detachably picking and holding the Z profile sheet pile 7 which is inserted through the through hole 102, and a supporting member 105 for supporting the movable jaw 104. The supporting member 105 moves toward the fixed jaw 103 by a hydraulic cylinder (not shown) to grasp the Z profile sheet pile 7.

When pressing the Z profile sheet piles 7 in, the fixed jaw 103 and the movable jaw 104 grasp and hold the Z profile sheet pile 7, and the chuck section 101 is rotated to change the direction of the Z profile sheet piles 7 one by one in right-and-left directions-to join the Z profile sheet piles 7 alternately at the clutches 73. Accordingly, a continuous wall (see, for example, Japanese Application Patent Laid-Open Publication No. 2002-294691) can be structured.

However, in the above method, since the Z profile sheet piles are pressed in one by one, the stiffness is low. Thus, there is a problem that it is difficult to stably press the Z profile sheet pile in and construction accuracy becomes low.

Also, after a Z profile sheet pile was pressed in, it is required to rotate the chuck section before pressing a next Z profile sheet pile in. Thus, it takes a long time to carry out a press-in operation. Moreover, since the Z profile sheet piles are pressed in one by one, the pitch to be constructed is short. Thus, the cost for construction per meter becomes high.

### SUMMARY OF THE INVENTION

The present invention has been developed in view of the above circumstances, and an object of the present invention is to provide a press-in apparatus for the Z profile sheet pile and press-in method of the Z profile sheet pile, in which construction can be stably carried out with high accuracy in a state where the Z profile sheet piles have high stiffness, and which can reduce the working hours and cost.

In the first aspect of the invention, as shown in FIGS. 1 and 2, the press-in apparatus for a Z profile sheet pile, comprises a press-in section (for example, a chuck section 2) for grasping a Z profile sheet pile having clutches 73 at both ends to press in,
wherein the press-in section presses two Z profile sheet piles in at a time in a state where the two Z profile sheet piles are joined each other at clutches thereof.

According to the invention, since two Z profile sheet piles are pressed in at a time in a state where the two Z profile sheet piles are joined each other at the clutches thereof, the Z profile sheet piles can be stably pressed in the ground in a state of having high stiffness in comparison to the earlier technique where Z profile sheet piles are pressed in one by one. Thus, the construction can be carried out with high accuracy.

Moreover, pressing the two Z profile sheet piles in at a time can realize the reduction of press-in work and the long pitch for construction at a time. Thus, the cost for construction can be reduced.

Preferably, as shown in FIG. 2, the press-in section comprises a grasping mechanism (for example, a fixed jaw 222 or a movable jaw 223) for grasping the two profile sheet piles individually to press in.

According to the invention, the grasping mechanism grasps the two Z profile sheet piles individually to press in, the Z profile sheet piles can be pressed in one by one alternately.

Thus, for example, when pressing the Z profile sheet piles in, even if the toe resistance by cobbles or gravels to the Z profile sheet piles are high, the area to receive the toe resistance becomes half by pressing the Z profile sheet piles in one by one. Therefore, the toe resistance can be reduced. Thus, the deformation of the Z profile sheet pile can be prevented, thereby making the press-in easy.

Preferably, for example as shown in FIG. 2, the grasping mechanism grasps each end portion (for example, flange portion 71a) of the two Z profile sheet piles which is opposite side of the clutches at which the two Z profile sheet piles are joined each other, individually.

According to the invention, the grasping mechanism grasps each of the end portions of the two Z profile sheet piles which is opposite side of the clutches at which the two Z profile sheet piles are joined each other. That is, the grasping mechanism grasps a portion near the forefront of the joined two Z profile sheet piles in a direction of movement of the press-in apparatus. Thus, the Z profile sheet piles can be controlled easily and pressed in with high accuracy.

This configuration can provide a compact press-in apparatus in view of the strength of the Z profile sheet piles. Moreover, for example, an auger apparatus or a jet hose (pipe) can be disposed in the convexities which are formed by joining two Z profile sheet piles, so that a simultaneous press-in method can be carried out.

Preferably, for example as shown in FIGS. 1. and 3, the press-in apparatus for a Z profile sheet pile further comprises a plurality of clamp parts (for example, clamp parts 5) for supporting the press-in section and clamping pressed-in Z profile sheet piles which were pressed in by the press-in section to receive a reaction force when grasping a new Z profile sheet pile in by the press-in section to press in,
wherein the plurality of clamp parts clamp each joint part S of clutches of the Z profile sheet piles which are joined each other.

According to the invention, the plurality of clamp parts clamp each joint part of clutches of the Z profile sheet piles. Thus, for example, when four clamp parts are provided, they clamp five pressed-in Z profile sheet piles. Therefore new Z profile sheet piles can be pressed in stably with high accuracy by receiving reaction force from the five Z profile sheet piles. Since the plurality of clamp parts clamp each joint part of the Z profile sheet piles, the clamp parts are not arranged in line in the back-and-forth directions but are arranged alternately on right and left sides seen from the back-and-forth directions. Thus, the inclination of the press-in section supported by the clamp parts in lateral direction can be prevented.

Preferably, the press-in method for pressing a Z profile sheet pile in, comprises the step of:
pressing the two Z profile sheet piles in at a time in a state where the two Z profile sheet piles are joined each other at the clutches thereof by using the press-in apparatus for a Z profile sheet pile.

According to the invention, the two Z profile sheet piles are pressed in at a time in a state where the two Z profile sheet piles are joined each other at the clutches thereof by using the press-in apparatus for a Z profile sheet pile, the Z profile sheet piles can be stably pressed in the ground in a state of having high stiffness in comparison to the earlier technique where Z profile sheet piles are pressed in one by one. Thus, the construction can be carried out with high accuracy.

Moreover, pressing the two Z profile sheet piles in at a time can realize the reduction of press-in work and the long pitch for construction at a time. Thus, the cost for construction can be reduced.

In the press-in method of a Z profile sheet pile, when pressing the two Z profile sheet piles in at a time, the two Z profile sheet piles may be pressed in alternately one by one through a plurality of steps in a state of maintaining the two Z profile sheet piles to be joined each other at the clutches thereof.

According to the invention, when pressing the two Z profile sheet piles in at a time, since the two Z profile sheet piles are pressed in alternately one by one through the plurality of steps in a state of maintaining the two Z profile sheet piles to be joined each other at the clutches thereof, the Z profile sheet piles can be stably pressed in without the Z profile sheet pile on the front side blurs, and the construction can be carried out with high accuracy in comparison with the case where the two Z profile sheet piles are pressed in at a time through the plurality of steps.

According to the press-in apparatus for the Z profile sheet pile and the press-in method of the Z profile sheet pile in the present invention, the two Z profile sheet piles are pressed in at a time in a state where the two Z profile sheet piles are joined each other at the clutches thereof. Thus, the construction can be stably carried out with high accuracy in a state where the Z profile sheet piles have high stiffness, and which can reduce the working hours and cost.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a schematic side view of a press-in apparatus for a Z profile sheet pile in the embodiment according to the present invention;

FIG. 2 is an enlarged plan view showing an example of a chuck section of the press-in apparatus for a Z profile sheet pile in the embodiment according to the present invention;

FIG. 3 is schematic plan view showing a positional relationship between joint parts of clutches of the pressed-in Z profile sheet piles and clamp parts;

FIGS. 4A-4D are enlarged plan views showing other modifications of a chuck section; and

FIG. 5 is an enlarged plan view showing a chuck section of an earlier developed press-in apparatus for a Z profile sheet pile.

### DETAILED DESCRIPTION OF THE PREFERRED EMBODIMENTS

Hereinafter, the preferred embodiments of the present invention will be described in detail by reference to the attached drawings.

The embodiment will be explained with a press-in apparatus for a Z profile sheet pile (hereinafter, referred to as press-in apparatus), which repeats the operations of pressing and embedding the Z profile sheet pile in by receiving reaction force from pressed-in Z profile sheet piles, and moving the pres-in apparatus on the pressed-in Z profile sheet piles to press a new Z profile sheet pile in, in order.

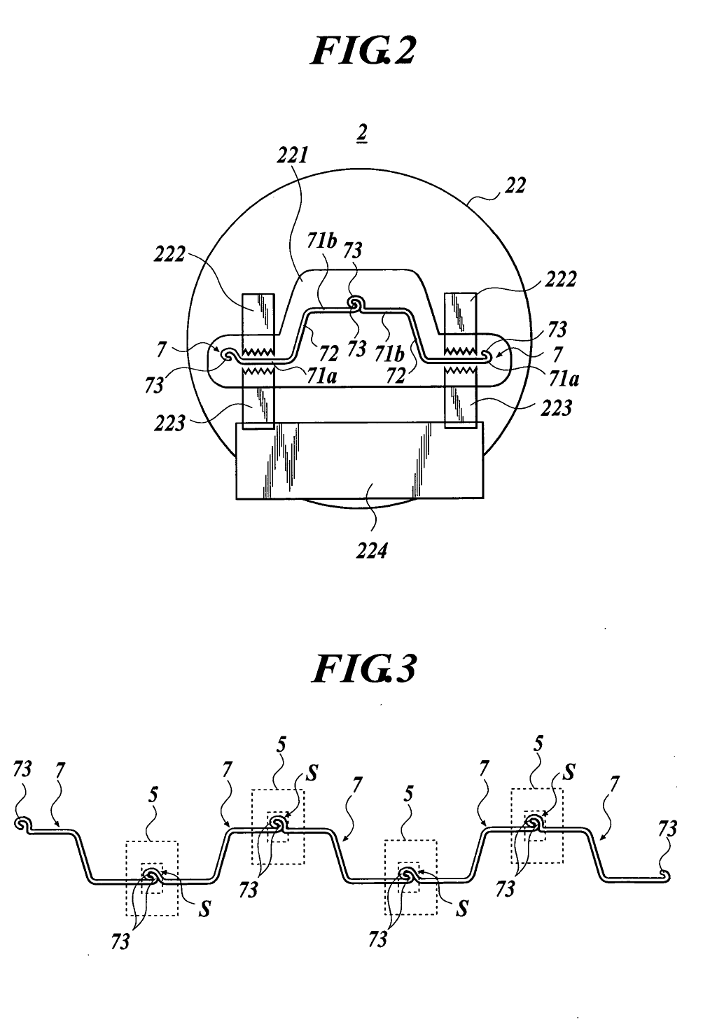

As shown in FIG. 2, the Z profile sheet pile 7 comprises two parallel flange parts 71a and 71b, a web part for integrally connecting the flange parts 71a and 71b, clutches 73 provided on the end portion of each of the flange parts 71a and 71b. In the embodiment, two Z profile sheet piles are vertically reversed each other and are joined at clutches 73 to form a U shape, and are pressed in at a time (refer to FIG. 3).

A configuration of the press-in apparatus will be explained.

The press-in apparatus 1 comprises a machine body section 3 and a chuck section 2 (press-in section) ascendably/descendably supported on the front side of the machine body section 3.

The machine body section 3 comprises a saddle 4 having four clamp parts (clamp parts) 5 for clamping the pressed-in Z profile sheet piles 7, and a mast which is provided to be movable back and forth to the saddle 4 and rotates on the saddle 4.

The clamp parts 5 are for clamping joint parts S (refer to FIG. 3) of the clutches 73 at which the pressed-in Z profile sheet piles 7 are joined each other, without deforming the clutches 73. Four clamp parts 5 are provided in back-and-forth directions drooping from the saddle 4. As shown in FIG. 3, the four clamp parts 5 are for clamping each of the joint parts S of the clutches 73 of five Z profile sheet piles 7 which are joined each other. The four clamp parts 5 are not arranged in line in the back-and-forth directions but are arranged alternately on right and left sides in the back-and-forth directions.

The clamp parts 5 are slidable back and forth to the saddle 4. The clamp parts 5 are driven to carry out the operations of clamping and releasing the pressed-in Z profile sheet piles 7.

The mast 6 is erected on the slide frame which is movable back and forth to the saddle 4, and is rotatable around the shaft in the up-and-down directions as a center.

A pair of rail parts 61 which extend in up-and-down directions are provided on the front surface side of the mast 6 in spaced relationship to each other in right-and-left directions. The sliding members 23 provided on the chuck section 2 are slidably engaged with the rail portions 6, so that the chuck section 2 can ascendably/descendably be supported by the machine body section 3.

A pair of vertical hydraulic cylinders 24 which extend to the chuck section 2 side are attached to the mast 6 to extend in the up-and-down directions. The vertical hydraulic cylinders 24 are in spaced relationship to each other in the right-and-left directions. The vertical hydraulic cylinders 24 are joined to the tip portions of arms 62 at the lower end portions thereof. When the vertical hydraulic cylinders 24 are driven, the cylinder rods expand and contract. Thus, the chuck section 2 moves up and down along the rails 61.

The chuck section 2 comprises a chuck body 21 and a chuck 22.

The chuck 22 grasps two Z profile sheet piles at a time in a state where the two Z profile sheet piles to be pressed in are joined each other at the clutches 73, and presses in the ground in order. As shown in FIG. 2, approximately U-shaped through hole 221 is formed in the chuck 2, through which two Z profile sheet piles are inserted. The chuck 22 is provided with fixed jaws 222 (grasping mechanism) and movable jaws 223 (grasping mechanism) for attachably/detachably grasping and holding each of the two Z profile sheet piles 7 which is inserted through the through hole 221 individually and pressing them in, and a supporting member 224 for supporting the movable jaws 223.

The fixed jaws 222 and the movable jaws 223 are provided to grasp each of the flange portions 71a which is the opposite side of the clutches 73 at which the two Z profile sheet piles are joined each other (refer to FIG. 2).

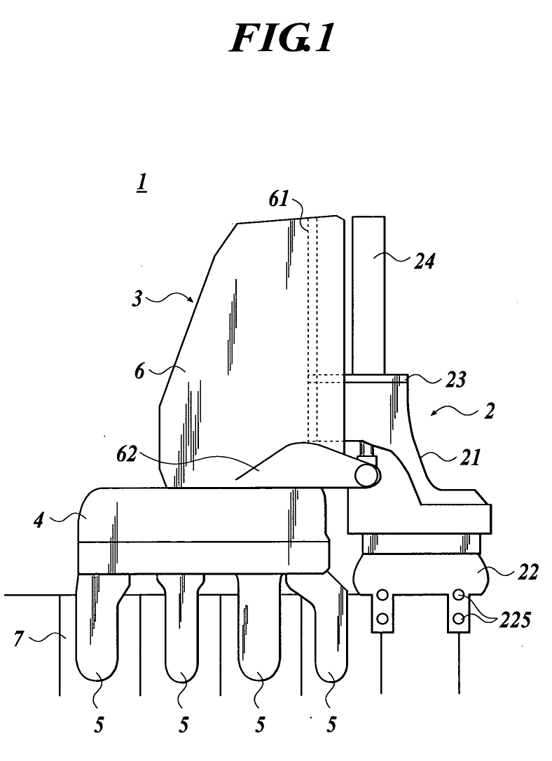

The supporting member 224 is provided to be movable in a direction toward the fixed jaws 222 or a direction away from the fixed jaws 222 by a hydraulic cylinder 225 (refer to FIG. 1).

The operations of grasping or releasing the each flange portion 71a of the two Z profile sheet piles 7 can be carried out by driving the chuck 22. Accordingly, the Z profile sheet piles can be grasped and pressed in every two piles or one pile in order.

The chuck 22 is rotatable around the vertical shaft which passes the center of the chuck 22. The operations of the above described press-in apparatus for the Z profile sheet pile will be explained referring to FIGS. 1 and 2.

The clamp parts 5 clamps the pressed-in Z profile sheet piles 7, and the chuck 22 grasps two Z profile sheet piles 7 at the same time in a state where the two Z profile sheet piles 7 are joined each other at the clutches 73. That is, the movable jaws 223 move in a direction toward the fixed jaws 222 through the supporting member 224 by driving the hydraulic cylinder 225, thereby grasping each flange portion 71a of the two Z profile sheet piles 7.

The vertical hydraulic cylinders 24 move the chuck section 2 downward to press the two Z profile sheet piles 7 in at the same time. When the amount of downward movement of the chuck 22 reaches the predetermined amount, and the two Z profile sheet piles 7 are embedded in the ground, the chuck 22 releases the two Z profile sheet piles 7. That is, by moving the movable jaws 223 in a direction away from the fixed jaws 223 through the supporting member 224 by driving the hydraulic cylinder 225, each flange portion 71a of the two Z profile sheet piles 7 is released. The vertical hydraulic cylinders 24 move the chuck section 2 upward, so that the two Z profile sheet piles 7 are detached from the chuck section 2.

The slide frame moves forward with respect to the saddle 4. The chuck 22 rotates 180° and grasps two Z profile sheet piles 7 to be pressed in next.

The vertical hydraulic cylinders 24 move the chuck section 2 downward a predetermined amount so as to press the next two Z profile sheet piles 7 in partway.

The clamp parts 5 release the pressed-in piles 7, and the vertical hydraulic cylinders 24 move the machine body section 3 upward. The saddle 4 is slid forward with respect to the slide base. The vertical hydraulic cylinders 24 move the machine body section 3 downward. The clamp parts 5 clamp the pressed-in Z profile sheet piles 7 which exist forward to receive reaction force generated in the pressed-in piles 7. The chuck 2 grasps the next two Z profile sheet piles 7 which were pressed in partway to press them in at the same time. That is, the chuck 22 grasps the two Z profile sheet piles 7 again, and the chuck section 22 is moved downward a predetermined amount to completely press the two Z profile sheet piles 7 in and embed in the ground. By repeating the above described steps, two Z profile sheet piles 7 are pressed in at a time in order. The Z profile sheet piles 7 are embedded in the ground so as to make directions of convexities which are formed by two joined Z profile sheet piles 7 face to opposite direction each other alternately (refer to FIG. 3).

According to the embodiment in the present invention, two Z profile sheet piles 7 are pressed in at a time in order in a state where two Z profile sheet piles are joined each other at the clutches 73 thereof, so that construction can be stably carried out with high accuracy in a state where Z profile sheet piles have high stiffness in comparison to the earlier developed method. Moreover, since two Z profile sheet piles 7 are pressed in at a time in order, the pitch to be constructed becomes long. Thus, the cost for the construction can be reduced.

Since the fixed jaws 222 and the movable jaws 223 of the chuck section 2 grasp each of two Z profile sheet piles individually, the Z profile sheet piles 7 can be pressed in one by one. Accordingly, even when the toe resistance received from the ground is high, the area to receive the toe resistance becomes half by pressing the Z profile sheet piles 7 in one by one. Therefore, the toe resistance can be reduced. Thus, the deformation of the Z profile sheet pile 7 can be prevented, thereby making the press-in easy.

Since the fixed jaws 222 and the movable jaws 223 grasp each flange portion 71a of the two Z profile sheet piles 7 which is the opposite side of the clutch 73 at which the two Z profile sheet piles 7 are joined each other, a portion near the forefront of the joined two Z profile sheet piles 7 in a direction of movement of the pile press-in apparatus are grasped. Thus, the Z profile sheet piles 7 can be controlled easily and pressed in with high accuracy. Moreover, the press-in apparatus can be compact in view of the strength of the Z profile sheet piles. Since an auger apparatus or a jet hose (pipe) can be disposed in the convexities which are formed by joining two Z profile sheet piles 7, a simultaneous press-in method can be carried out.

The four clamp parts 5 grasp each joint part S of the clutches 73 of the pressed-in five Z profile sheet piles 7 which are joined each other. Thus, as shown in FIG. 3, the press-in apparatus can receive reaction force from the five Z profile sheet piles 7 to stably press the Z profile sheet piles 7 in with high accuracy. The four clamp parts 5 are arranged alternately on right and left sides in the back-and-forth directions. Thus, the inclination of the chuck 2 in lateral direction can be prevented.

The present invention is not limited to the above described embodiment, and changes may be made without departing from the spirit of the present invention.

For example, in the above embodiment, when pressing two Z profile sheet piles 7 in at a time in order, the two Z profile sheet piles 7 are pressed in at the same time through a plurality of steps in a state where the two Z profile sheet piles are joined at the clutches 73. However, the two Z profile sheet piles 7 may be pressed in alternately one by one through the plurality of steps in a state where the two Z profile sheet piles 7 are joined at the clutches 73.

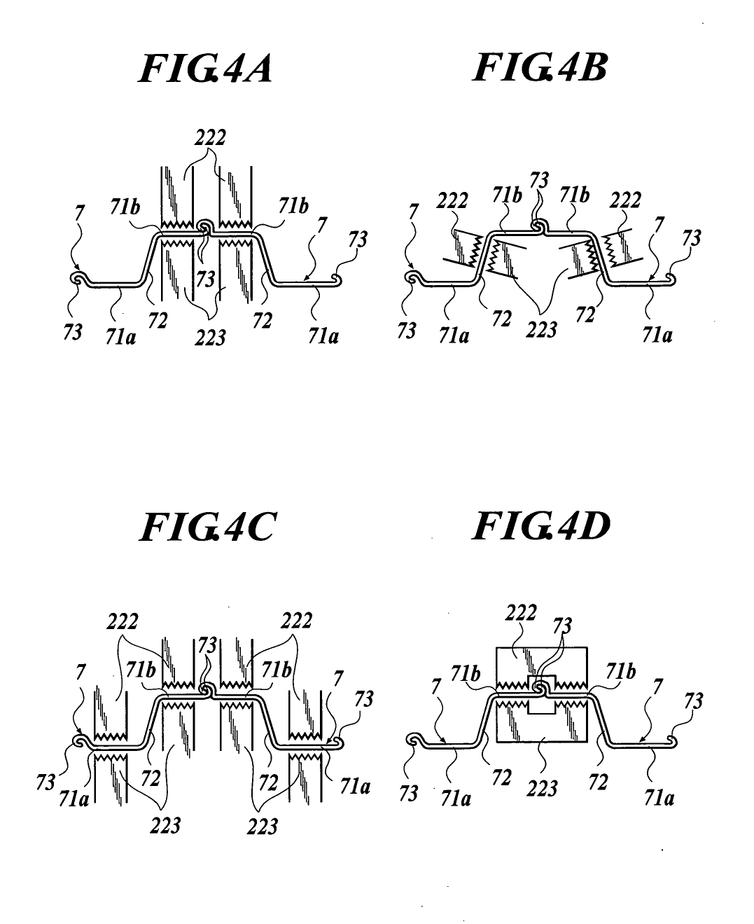

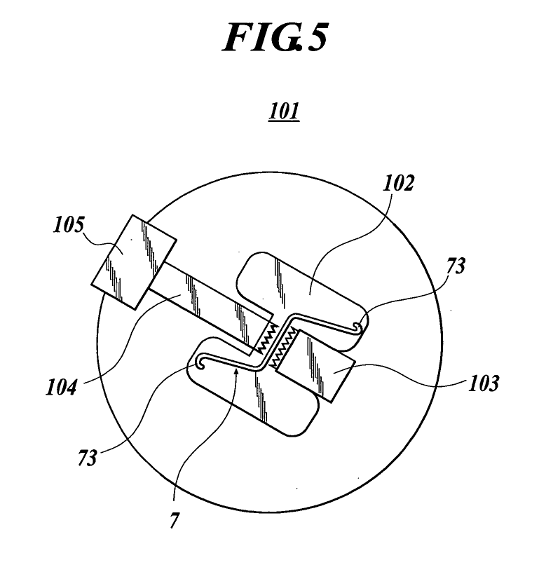

As described above, when pressing two Z profile sheet piles 7 in at a time in order, when the Z profile sheet piles are pressed in alternately one by one through the plurality of steps, the Z profile sheet piles 7 can be stably pressed in without the Z profile sheet pile 7 on the front side blurs, and the construction can be carried out with high accuracy in comparison with the case where the two Z profile sheet piles 7 are pressed in at a time through the plurality of steps. In the above embodiment, the fixed jaws 222 and the movable jaws 223 of the chuck section 2 are provided to grasp each flange portion 71a which is the opposite side of the clutches 73 at which the two Z profile sheet piles 7 are joined each other. However, the chuck section 2 may be provided at positions as shown in FIG. 4A-4B.

That is, in FIG. 4A, the chuck section 2 is provided at the flange portions 71b which are the opposite side of the flange portions 71a of the Z profile sheet piles 7 (the side of the clutches 73 which are joined each other). In FIG. 4B, the chuck sections 2 are provided at wave portions 72 of each Z profile sheet pile 7. In FIG. 4C, the chuck sections 2 are provided at both of the flange portions 71a, 71b of each Z profile sheet pile 7.

In FIG. 4A-4C, the configuration is such that each of the two Z profile sheet piles 7 can be grasped individually to press in. Thus, when the toe resistance is high during pressing the Z profile sheet piles 7 in, the toe resistance can be reduced by pressing the Z profile sheet piles 7 in one by one. Accordingly, the deformation of the Z profile sheet piles 7 can be prevented, thereby making the press-in easy.

In FIG. 4D, the fixed jaws 222 and the movable jaws 223 for grasping each flange 71a in FIG. 2 are integrally formed, so that two Z profile sheet piles 7 can be grasped at the same time.

In the embodiment, a section for grasping two Z profile sheet piles 7 comprises the fixed jaws 222, the movable jaws 223, the supporting member 224, and the hydraulic cylinder 225. However, the section for grasping two Z profile sheet piles 7 may comprise four hydraulic cylinders for grasping each flange 71a.

The clamp parts 5 are configured to clamp the joint parts S of the pressed-in Z profile sheet piles 7 so as not to deform the clutches 73 as shown in FIG. 3. However, when the Z profile sheet piles 7a are not removed after the construction of the Z profile sheet piles 7, the clamp parts 5 may be configured to directly clamp the clutches 73.

The entire disclosure of Japanese Patent Application No. Tokugan 2003-364857 which was filed on Oct. 24, 2003, including specification, claims, drawings and summary are incorporated herein by reference in its entirety.

1. A press-in apparatus for a Z profile sheet pile, comprising a press-in section for grasping a Z profile sheet pile having clutches at both ends to press in,
wherein the press-in section presses two Z profile sheet piles in at a time in a state where the two Z profile sheet piles are joined each other at clutches thereof.

2. The press-in apparatus for a Z profile sheet pile as claimed in claim 1, wherein the press-in section comprises a grasping mechanism for grasping the two profile sheet piles individually to press in.

3. The press-in apparatus for a Z profile sheet pile as claimed in claim 2, wherein the grasping mechanism grasps each end portion of the two Z profile sheet piles which is opposite side of the clutches at which the two Z profile sheet piles are joined each other, individually.

4. The press-in apparatus for a Z profile sheet pile as claimed in any one of claims 1-3 further comprising a plurality of clamp parts for supporting the press-in section and clamping Z profile sheet piles which were pressed in by the press-in section to receive a reaction force when grasping a new Z profile sheet pile by the press-in section to press in,
wherein the plurality of clamp parts clamp each joint part of the clutches of the Z profile sheet piles which are joined each other.

5. A press-in method for pressing a Z profile sheet pile in, comprising the step of:
pressing the two Z profile sheet piles in at a time in a state where the two Z profile sheet piles are joined each other at the clutches thereof by using the press-in apparatus for a Z profile sheet pile as claimed in any one of claims 1-3.

6. A press-in method for pressing a Z profile sheet pile in, comprising the step of:
pressing the two Z profile sheet piles in at a time in a state where the two Z profile sheet piles are joined each other at the clutches thereof by using the press-in apparatus for a Z profile sheet pile as claimed in claim 4.

7. The press-in method for pressing a Z profile sheet pile in, as claimed in claim 5, wherein when pressing the two Z profile sheet piles in at a time, the two Z profile sheet piles are pressed in alternately one by one through a plurality of steps in a state of maintaining the two Z profile sheet piles to be joined each other at the clutches thereof.

8. The press-in method for pressing a Z profile sheet pile in, as claimed in claim 6, wherein when pressing the two Z profile sheet piles in at a time, the two Z profile sheet piles are pressed in alternately one by one through a plurality of steps in a state of maintaining the two Z profile sheet piles to be joined each other at the clutches thereof.
